(19) United States
(12) Patent Application Publication
(10) Pub. No.: US 2021/0105627 A1
(43) Pub. Date: Apr. 8, 2021

(54) METHOD AND A DEVICE FOR AUTHORIZING A USER EQUIPMENT TO CONNECT TO A WIRELESS ACCESS POINT

(71) Applicant: LIANSHANG (XINCHANG) NETWORK TECHNOLOGY CO., LTD., SHAOXING (CN)

(72) Inventor: Han CHENG, SHAOXING (CN)

(21) Appl. No.: 17/124,511

(22) Filed: Dec. 17, 2020

Related U.S. Application Data
(63) Continuation of application No. PCT/CN2019/092219, filed on Jun. 21, 2019.

(30) Foreign Application Priority Data
Jun. 29, 2018 (CN) 201810699909.9

(51) Int. Cl. H04W 12/63; H04W 12/73; H04W 48/02; H04W 48/20; H04W 76/10; H04L 29/06

(52) U.S. Cl. CPC H04W 12/63; H04W 12/73; H04L 63/18; H04W 48/20; H04W 76/10; H04W 48/02

(57) ABSTRACT

The present application provides a method for authorizing a user equipment to connect to a wireless access point. Specifically, the method comprises: receiving a connection authorization request uploaded by the user equipment, wherein the connection authorization request comprises authorization identification information obtained by the user equipment through scanning a QR code; determining whether to authorize the user equipment to connect to a wireless access point corresponding to the QR code based on the authorization identification information; and if the user equipment is authorized to connect to the wireless access point corresponding to the QR code, transmitting corresponding authorization instruction information to a wireless routing device which provides the wireless access point, wherein the authorization instruction information comprises equipment identification information of the user equipment. The present application eliminates users from complicated operations during the connection process, makes the connection process simpler and more efficient, and improves use experience of users.

### CROSS REFERENCE TO THE RELATED APPLICATION

This application is the continuation application of International Application No. PCT/CN2019/092219, filed on Jun. 21, 2019, which is based upon and claims priority to Chinese Patent Application No. 201810699909.9, filed on Jun. 29, 2018, the entire contents of which are incorporated herein by reference.

### FIELD

The present application relates to communication, and more specifically relates to a technology for authorizing a user equipment to connect to a wireless access point.

### BACKGROUND

With the popularity of mobile devices and the development of the Internet, people increasingly rely on wireless networks in their daily lives. Public wireless networks have low security. Connection authentication of wireless networks is usually employed to restrict unauthorized users from accessing the wireless networks, thereby ensuring the security.

When a mobile device connects to a wireless network, cooperation with a routing device is often required. A method for authentication by a traditional router is passive. A user who requests connection is required to provide a password for authentication, and wireless connections may only be available after the authentication is passed.

### SUMMARY

It is an object of the present application to provide a method and a device for authorizing a user equipment to connect to a wireless access point.

According to an aspect of the present application, it is provided a method, implemented at a network device, for authorizing a user equipment to connect to a wireless access point. The method comprises:

receiving a connection authorization request uploaded by the user equipment, wherein the connection authorization request comprises authorization identification information obtained by the user equipment through scanning a QR code;

determining whether to authorize the user equipment to connect to a wireless access point corresponding to the QR code based on the authorization identification information; and

if the user equipment is authorized to connect to the wireless access point corresponding to the QR code, transmitting corresponding authorization instruction information to a wireless routing device which provides the wireless access point, wherein the authorization instruction information comprises equipment identification information of the user equipment.

According to another aspect of the present application, it is provided a method, implemented at a wireless routing device, for authorizing a user equipment to connect to a wireless access point. The method comprises:

receiving authorization instruction information which is transmitted by a network device and corresponds to a wireless access point provided by the wireless routing device, wherein the authorization instruction information comprises equipment identification information of the user equipment; and

executing the authorization instruction information to authorize the user equipment to connect to the wireless access point.

According to yet another aspect of the present application, it is provided a method, implemented at a user equipment, for authorizing the user equipment to connect to a wireless access point. The method comprises:

obtaining authorization identification information corresponding to a QR code by scanning the QR code; and

transmitting a connection authorization request to a network device, wherein the connection authorization request comprises the authorization identification information.

According to an aspect of the present application, it is provided a method for authorizing a user equipment to connect to a wireless access point. The method comprises:

obtaining, by the user equipment, authorization identification information corresponding to a QR code by scanning the QR code; and transmitting a connection authorization request to a network device, wherein the connection authorization request comprises the authorization identification information;

receiving, by the network device, the connection authorization request, and determining whether to authorize the user equipment to connect to a wireless access point corresponding to the QR code based on the authorization identification information;

if the user equipment is authorized to connect to the wireless access point corresponding to the QR code, transmitting, by the network device, corresponding authorization instruction information to a wireless routing device which provides the wireless access point, wherein the authorization instruction information comprises equipment identification information of the user equipment; and

receiving, by the wireless routing device, the authorization instruction information, and executing the authorization instruction information to authorize the user equipment to connect to the wireless access point.

According to an aspect of the present application, it is provided a device for authorizing a user equipment to connect to a wireless access point. The device comprises:

a processor; and

a memory arranged to store computer executable instructions, when executed, cause the processor to:

receive a connection authorization request uploaded by the user equipment, wherein the connection authorization request comprises authorization identification information obtained by the user equipment through scanning a QR code;

determine whether to authorize the user equipment to connect to a wireless access point corresponding to the QR code based on the authorization identification information; and

if the user equipment is authorized to connect to the wireless access point corresponding to the QR code, transmit corresponding authorization instruction information to a wireless routing device which provides the wireless access point, wherein the authorization instruction information comprises equipment identification information of the user equipment.

According to another aspect of the present application, it is provided a device for authorizing a user equipment to connect to a wireless access point. The device comprises:

a processor; and

a memory arranged to store computer executable instructions, when executed, cause the processor to:

receive authorization instruction information which is transmitted by a network device and corresponds to a wireless access point provided by the wireless routing device, wherein the authorization instruction information comprises equipment identification information of the user equipment; and

execute the authorization instruction information to authorize the user equipment to connect to the wireless access point.

According to yet another aspect of the present application, it is provided a device for authorizing a user equipment to connect to a wireless access point. The device comprises:

a processor; and

a memory arranged to store computer executable instructions, when executed, cause the processor to:

obtain authorization identification information corresponding to a QR code by scanning the QR code; and

transmit a connection authorization request to a network device, wherein the connection authorization request comprises the authorization identification information.

According to an aspect of the application, it is provided a computer readable medium comprising instructions, when executed, cause a system to:

receive a connection authorization request uploaded by the user equipment, wherein the connection authorization request comprises authorization identification information obtained by the user equipment through scanning a QR code;

determine whether to authorize the user equipment to connect to a wireless access point corresponding to the QR code based on the authorization identification information; and

if the user equipment is authorized to connect to the wireless access point corresponding to the QR code, transmit corresponding authorization instruction information to a wireless routing device which provides the wireless access point, wherein the authorization instruction information comprises equipment identification information of the user equipment.

According to another aspect of the application, it is provided a computer readable medium comprising instructions, when executed, cause a system to:

receive authorization instruction information which is transmitted by a network device and corresponds to a wireless access point provided by the wireless routing device, wherein the authorization instruction information comprises equipment identification information of the user equipment; and

execute the authorization instruction information to authorize the user equipment to connect to the wireless access point.

According to yet another aspect of the application, it is provided a computer readable medium comprising instructions, when executed, cause a system to:

obtain authorization identification information corresponding to a QR code by scanning the QR code; and

transmit a connection authorization request to a network device, wherein the connection authorization request comprises the authorization identification information.

Compared with the prior art, in the present disclosure, the wireless routing device performs wireless connection authorization on the user equipment before the user equipment initiates connection authentication to the wireless access point, which eliminates users from complicated operations during the connection process, makes the connection process simpler and more efficient, and improves use experience of users. Also, in this solution, when the user equipment scans QR codes of some places or users, it may transmit the QR codes to the network device. The network device may also determine whether to authorize wireless connection to the user equipment while performing identity verification, so that the user is unaware of the process of connecting to the wireless access point by the user equipment, which greatly improves user experience.

### DESCRIPTIONS OF THE DRAWINGS

Other features, objects, and advantages of the present application will become more apparent by reading the detailed description of non-limiting embodiments with reference to the following drawings:

FIG. 1 shows a topology diagram of a system for authorizing a user equipment to connect to a wireless access point according to an aspect of the present application;

FIG. 2 shows a flowchart of a method, implemented at a network device, for authorizing a user equipment to connect to a wireless access point according to an aspect of the present application;

FIG. 3 shows a flowchart of a method, implemented at a wireless routing device, for authorizing a user equipment to connect to a wireless access point according to another aspect of the present application;

FIG. 4 shows a flowchart of a method, implemented at a user equipment, for authorizing the user equipment to connect to a wireless access point according to yet another aspect of the present application;

FIG. 5 shows a diagram of a systematic method for authorizing a user equipment to connect to a wireless access point according to an aspect of the present application;

FIG. 6 shows a schematic device diagram of a network device for authorizing a user equipment to connect to a wireless access point according to an aspect of the present application;

FIG. 7 shows a schematic device diagram of a wireless routing device for authorizing a user equipment to connect to a wireless access point according to another aspect of the present application;

FIG. 8 shows a schematic equipment diagram of a user equipment for authorizing a user equipment to connect to a wireless access point according to yet another aspect of the present application;

FIG. 9 shows a schematic diagram of a system for authorizing a user equipment to connect to a wireless access point according to an aspect of the present application; and

FIG. 10 shows an exemplary system which may be used to implement the various embodiments described in the present application.

The identical or similar reference numerals in the drawings represent the identical or similar components.

### DETAILED EMBODIMENTS

The application is further described in detail below with reference to the accompanying drawings.

In a typical configuration of the present application, a terminal, a device of a service network and a trusted party all include one or more processors (CPUs), an input/output interface, a network interface and a memory.

The memory may include a non-permanent memory, a random access memory (RAM) and/or a non-volatile memory and the like in a computer-readable medium, such as a read-only memory (ROM) or a flash memory (flash RAM)). A memory is an example of a computer-readable medium.

A computer-readable medium comprises permanent and non-permanent, movable and non-movable media and may implement information storage by means of any method or technology. Information may be computer-readable instructions, data structures, program devices or other data. The examples of a computer storage medium include but are not limited to a phase change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, compact disk read-only memory (CD-ROM), a digital versatile disc (DVD) or other optical storages, a magnetic cassette tape, and magnetic tape and magnetic disk storage or other magnetic storage devices or any other non-transmission medium, which can be used to store information that can be accessed by a computing device.

The devices referred to in the present application include, but are not limited to, user equipments, network devices, or devices formed by the integration of user equipments and network devices through a network. User equipments include but are not limited to any type of mobile electronic products capable of human-machine interaction with users (e.g., via touchpads), for example, an intelligent phone, a tablet, etc. The mobile electronic products can run on any operating system, such as android operating system, iOS operating system, etc. Network devices include an electronic device of automatically performing numeral calculations and information processing according to preset or stored instructions. Its hardware includes but is not limited to micro-processors, application specific integrated circuits (ASIC), programmable logic device (PLD), field programmable gate array (FPGA), digital signal processors (DSP), embedded devices, etc. Network devices include but are not limited to: computers, mainframes, single network server, a cloud composed of multiple network server sets or multiple servers. Cloud as used herein is formed by a massive amount of computers or network servers based on cloud computing, wherein cloud computing is a type of distributed computing, which is a virtual super computer composed of a group of loosely coupled computer sets. Networks include but are not limited to internet, Wide Area Network (WAN), Metropolitan Area Network (MAN), Local Area Network (LAN), Virtual Private Network (VPN), wireless ad-hoc network, etc. In one embodiment, the device may also be programs running on user equipments, network devices, or user equipments and network devices, network devices, touch terminals, or a device composed by integration of network devices and touch terminals through a network.

Of course, the above mentioned device is merely an example. Other existing devices or those that may appear in the future fall within the protection scope of the application and are incorporated herein by reference, if applicable to the present application.

In the description of the present application, the term “multiple” means two or more, unless it is clearly and specifically defined otherwise.

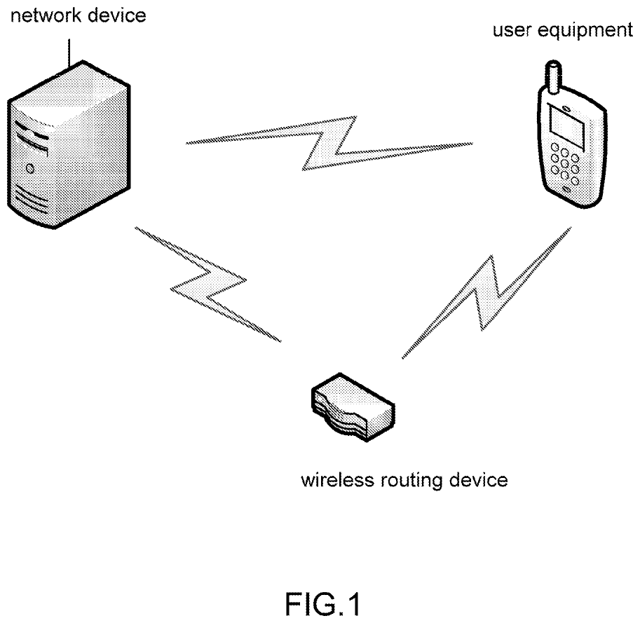

FIG. 1 shows a typical scenario of the present application in which a user equipment obtains authorization instruction information through interaction with a network device and a wireless routing device executes the authorization instruction information to authorize the user equipment to connect to a wireless access point provided by the wireless routing device. This solution is implemented with cooperation of the user equipment, the wireless routing device and the network device.

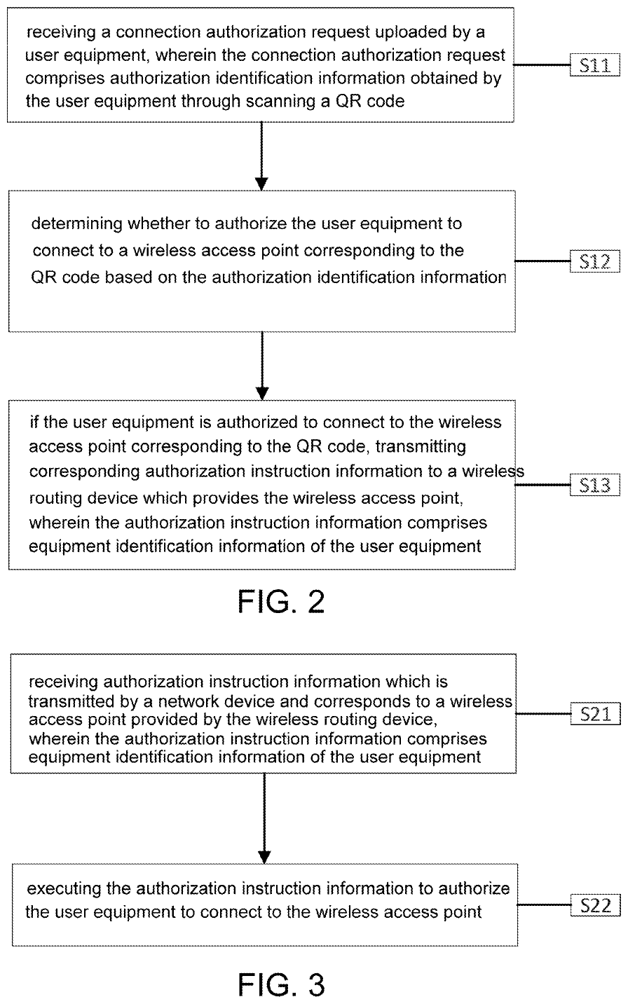

FIG. 2 shows a method, implemented at a network device, for authorizing a user equipment to connect to a wireless access point according to an aspect of the present application. The method comprises step S11, step S12 and step S13. In step S11, the network device receives a connection authorization request uploaded by the user equipment, wherein the connection authorization request comprises authorization identification information obtained by the user equipment through scanning a QR code. In step S12, the network device determines whether to authorize the user equipment to connect to a wireless access point corresponding to the QR code based on the authorization identification information. In step S13, if the user equipment is authorized to connect to the wireless access point corresponding to the QR code, the network device transmits corresponding authorization instruction information to a wireless routing device which provides the wireless access point, wherein the authorization instruction information comprises equipment identification information of the user equipment.

Specifically, in Step S11, the network device receives a connection authorization request uploaded by the user equipment, wherein the connection authorization request comprises authorization identification information obtained by the user equipment through scanning a QR code. For example, the connection authorization request includes but is not limited to authorization identification information obtained by the user equipment through scanning a QR code, wherein the authorization identification information includes but is not limited to an authorization code obtained by a user through scanning a QR code, and corresponding scene identification information obtained by a user through scanning a QR code, etc. The user holds a user equipment such as a mobile phone, etc. The user equipment scans a QR code through a camera device based on the user's operation to obtain corresponding authorization identification information, and transmits a connection authorization request to the network device. The network device receives the connection authorization request.

In step S12, the network device determines whether to authorize the user equipment to connect to a wireless access point corresponding to the QR code based on the authorization identification information.

In step S13, if the user equipment is authorized to connect to the wireless access point corresponding to the QR code, the network device transmits corresponding authorization instruction information to a wireless routing device which provides the wireless access point, wherein the authorization instruction information comprises equipment identification information of the user equipment. For example, the authorization instruction information includes but is not limited to equipment identification information of the user equipment, such as MAC address information of the user equipment, etc., for the wireless routing device to directly validate authentication and establish a wireless connection when the user equipment transmits a connection authentication request. If the network device authorizes the user equipment to connect to the wireless access point corresponding to the QR code, the network device transmits authorization instruction information to a wireless routing device corresponding to the wireless access point.

For example, a user holds a mobile phone. The user uses the mobile phone to scan a QR code for wireless connection authorization in a mall. The mobile phone scans the QR code with a camera device and obtains an authorization code corresponding to the QR code. The authorization code may be generated based on mall-related information, user-related information, time and the like which are built in the QR code. If the mall is WD mall and the user-related information is user name of JIA, corresponding authorization code is generated as WD-JIA-20180601. The mobile phone then transmits a connection authorization request for the wireless connection authorization in the mall to a server, wherein the connection authorization request comprises the authorization code corresponding to the QR code. The server receives the connection authorization request, and determines that corresponding scene is WD mall based on the authorization code in the connection authorization request as well as an encoding rule for the authorization code, and then queries, in a database of wireless access points, available wireless access points corresponding to WD mall, such as multiple wireless access points WD001, WD002, etc. If the authorization code conforms to the encoding rule, the server authorizes the user equipment to connect to wireless access points WD001, WD002, etc. Alternatively, the server stores some authorization codes uploaded by a merchant, and the server compares the authorization code uploaded by the mobile phone with the authorization codes uploaded by this merchant for a match. If the authorization code uploaded by the mobile phone matches one of the authorization codes uploaded by the same merchant, the server authorizes the user equipment to connect to wireless access points WD001, WD002, etc. The server then transmits authorization instruction information to wireless routing devices corresponding to wireless access points WD001, WD002, etc., wherein the authorization instruction information comprises MAC address information of the mobile phone. The wireless routing devices corresponding to wireless access points WD001, WD002, etc., receive the authorization instruction information, and execute the authorization instruction information to authorize wireless connection to the MAC address corresponding to the mobile phone. When the mobile phone transmits a connection authentication request to wireless access point WD001 provided by a wireless routing device, the wireless routing device recognizes the MAC address information of the mobile phone in the connection authentication request, and returns corresponding authentication pass response information directly to the mobile phone. The mobile phone receives the authentication pass response information, and a wireless connection between the mobile phone and wireless access point WD001 is established.

Of course, the above mentioned authorization identification information is merely an example. Other existing authorization identification information or those that may appear in the future fall within the protection scope of the application and are incorporated herein by reference, if applicable to the present application.

In some embodiments, the connection authorization request further comprises identification information of the wireless access point corresponding to the QR code. In step S12, the network device determines whether to authorize the user equipment to connect to the wireless access point corresponding to the identification information of the wireless access point based on the authorization identification information. For example, the connection authorization request further comprises access point identification information of the wireless access point corresponding to the QR code. The network device determines whether to authorize the user equipment to connect to the wireless access point corresponding to the access point identification information based on the authorization identification information.

For example, a server receives a connection authorization request transmitted by a user equipment, wherein the connection authorization request comprises authorization identification information obtained through scanning of a QR code as well as access point identification information of multiple wireless access points in WD mall contained in the QR code such as wireless access points WD001, WD002, etc. The server determines whether the authorization identification information satisfies an authorization condition, for example, whether an authorization code satisfies a preset encoding rule or matches one of authorization codes of a merchant received by the server. If so, the server determines to authorize a mobile phone to connect to wireless access points such as WD001, WD002, etc. The server then transmits authorization instruction information to wireless routing devices corresponding to wireless access points WD001, WD002, etc., wherein the authorization instruction information comprises MAC address information of the mobile phone.

Of course, the above mentioned identification information for the wireless access point is merely an example. Other existing identification information for the wireless access point or those that may appear in the future fall within the protection scope of the application and are incorporated herein by reference, if applicable to the present application.

In some embodiments, step S12 comprises a sub-step S121 (not shown) and a sub-step S122 (not shown). In Step S121, the network device determines the wireless access point corresponding to the QR code. In Step S122, the network device determines whether to authorize the user equipment to connect to the wireless access point based on the authorization identification information. For example, the network device determines the wireless access point corresponding to the QR code, such as an available wireless access point in the vicinity contained in the QR code to which the user equipment was pre-connected, and determines whether to authorize the user equipment to connect to the wireless access point based on the authorization identification information.

For example, a server receives a connection authorization request transmitted by a mobile phone. The connection authorization request contains access point identification information of multiple wireless access points in WD mall contained in the QR code currently scanned by the mobile phone such as wireless access points WD001, WD002, etc. Alternatively, the authorization request contains identification information of WD mall contained in the QR code scanned by the user equipment. The server stores a mapping relationship between identification information of the mall and the wireless access points. The server determines corresponding wireless access points according to the identification information of WD mall. The server then determines whether the authorization identification information satisfies an authorization condition, for example, whether an authorization code satisfies a preset encoding rule or matches one of authorization codes of a merchant received by the server. If so, the server determines to authorize the mobile phone to connect to wireless access points such as WD001, WD002, etc. The server then transmits authorization instruction information to wireless routing devices corresponding to wireless access points WD001, WD002, etc., wherein the authorization instruction information comprises MAC address information of the mobile phone.

In some embodiments, in step S121, the network device determines information on an activity event corresponding to the QR code, and queries and obtains, in a database of wireless access points, a registered wireless access point corresponding to the activity event according to the information on the activity event as the wireless access point corresponding to the QR code. For example, the user equipment scans QR code information corresponding to information on a certain activity event such as a concert, a rally, etc., based on the user's operation. The QR code information contains identification information of the activity event corresponding to the information on the activity event. The network device stores wireless access point(s) registered to the identification information of the activity event. The network device determines corresponding information on the activity event according to a QR code uploaded by the user, and queries and determines a corresponding wireless access point in a database as the wireless access point corresponding to the QR code.

For example, a user holds a mobile phone. The user is prepared to go to XX concert. The user scans a QR code corresponding to connection authorization on an admission ticket for XX concert through the mobile phone, and transmits a connection authorization request containing the QR code to a server. The server queries, in a database, multiple wireless access points registered to a venue of the concert such as wireless access points XXYCH001, XXYCH002, etc., according to concert identification information of XX concert contained in the QR code such as a serial number composed of a leading actor and time of the concert, etc. The server then determines whether to authorize the mobile phone to connect to the multiple wireless access points such as XXYCH001, XXYCH002, etc., according to authorization identification information in the QR code.

Of course, the above mentioned information on the activity event is merely an example. Other existing information on the activity event or those that may appear in the future fall within the protection scope of the application and are incorporated herein by reference, if applicable to the present application.

In some embodiments, in step S121, the network device determines information on a venue corresponding to the QR code, and queries and obtains, in a database of wireless access points, a wireless access point deployed by the corresponding venue as the wireless access point corresponding to the QR code, according to the information on the venue. For example, the user equipment scans QR code information corresponding to information on a certain venue such as a museum, a library, etc., based on the user's operation. The QR code information contains identification information of the venue corresponding to the information on the venue. The network device stores wireless access point(s) deployed by the venue. The network device determines corresponding information on the venue according to a QR code uploaded by the user, and queries and determines a wireless access point corresponding to the venue in a database as the wireless access point corresponding to the QR code.

For example, a user holds a mobile phone. The user is prepared to go to SH library to read books. The user scans a QR code for connection authorization corresponding to SH library on an admission ticket for the library through the mobile phone, and transmits a connection authorization request containing the QR code to the server. The server queries, in a database, multiple wireless access points registered to a venue of SH library such as wireless access points SHTSG001, SHTSG002, etc., according to the SH library identification information of SH library contained in the QR code, such as a serial number composed of a location and a name of the library, etc. The server then determines whether to authorize the mobile phone to connect to the multiple wireless access points such as SHTSG001, SHTSG002, etc., according to authorization identification information in the QR code.

Of course, the above mentioned information on the venue is merely an example. Other existing information on the venue or those that may appear in the future fall within the protection scope of the application and are incorporated herein by reference, if applicable to the present application.

In some embodiments, in step S121, the network device determines information on a wireless routing device corresponding to the QR code, and queries and obtains, in a database of wireless access points, a wireless access point provided by the corresponding wireless routing device as the wireless access point corresponding to the QR code, according to the information on the wireless routing device. For example, the user equipment scans QR code information corresponding to a certain wireless routing device based on the user's operation. The QR code information comprises device identification information of the wireless routing device corresponding to the wireless routing device, such as MAC address information of the wireless routing device. The network device stores wireless access point(s) provided by the wireless routing device. The network device determines a corresponding wireless routing device according to the QR code uploaded by the user, and queries and determines a wireless access point corresponding to the wireless routing device in a database as the wireless access point corresponding to the QR code.

For example, a user holds a mobile phone. The user is going to a certain square for a visit where a wireless routing device is installed. The user scans a QR code corresponding to connection authorization in the vicinity of the wireless routing device on the square through the mobile phone, and transmits a connection authorization request containing the QR code to a server. The server queries, in a database, multiple wireless access points provided by the wireless routing device, such as wireless access points GC001, GC002, etc., according to device identification information of the wireless routing device contained in the QR code, such as MAC address information of the wireless routing device, etc. The server then determines whether to authorize the mobile phone to connect to the multiple wireless access points such as GC001, GC002 etc., according to authorization identification information in the QR code.

In some embodiments, in step S121, the network device determines information on a device owner corresponding to the QR code, and queries and obtains, in a database of wireless access points, a wireless access point owned by the corresponding device owner as the wireless access point corresponding to the QR code, according to the information on the device owner. For example, the user equipment scans a QR code information corresponding to a device owner based on the user's operation. The QR code information contains user identification information corresponding to the device owner, such as user-related information, mobile phone number and the like of the device owner, etc. The network device stores wireless access point(s) owned by the device owner. The network device determines the corresponding device owner according to the QR code uploaded by the user, and queries and determines a wireless access point owned by the device owner in a database as the wireless access point corresponding to the QR code.

For example, user A holds a mobile phone. User a goes to user b's home for a visit. Mobile phone B corresponding to user b has been bound to wifi at user b's place, and this mapping relationship is stored in a server. User a scans a QR code corresponding to connection authorization from user b through the mobile phone, and transmits a connection authorization request containing the QR code to the server. The server queries a wireless access point bound to user b such as YHyi001 in a database according to device owner identification information of user b contained in the QR code such as user information, mobile phone number and the like of user b, etc. The server then determines whether to authorize the mobile phone to connect to wireless access point YHyi001 according to authorization identification information in the QR code.

Of course, the above mentioned information on the device owner is merely an example. Other existing information on the device owner or those that may appear in the future fall within the protection scope of the application and are incorporated herein by reference, if applicable to the present application.

In some embodiments, in step S122, the network device determines whether to authorize the user equipment to connect to the wireless access point based on the authorization identification information as well as authority information which is granted to a user holding the user equipment by a provider of the wireless access point;

wherein the authority information comprises any one of the following:

permission to connect to all of the wireless access points of the provider;

permission to connect to parts of the wireless access points of the provider, wherein parts of the wireless access point cover an area of the provider where the user is active.

prohibition from connecting to the wireless access point.

For example, the network device stores authority information which is granted to a user of the user equipment by a provider of the wireless access point. The network device determines whether to authorize the user equipment to connect to the wireless access point based on the authorization identification information, and further determines permission to connect to the wireless access point for the user based on the authority information. The permission includes but is not limited to: permission to connect to all of the wireless access points of the provider; permission to connect to parts of the wireless access points of the provider, wherein parts of the wireless access point cover an area of the provider where the user is active; and prohibition from connecting to the wireless access point.

For example, user a holds a mobile phone. User a goes to user b's home for a visit. Mobile phone B corresponding to user b has been bound to wifi at user b's place, and this mapping relationship is stored in a server. User a scans a QR code corresponding to connection authorization from user b through the mobile phone, and transmits a connection authorization request containing the QR code to the server. The server queries, in a database, wireless access points bound to user b such as wireless access points YHyi001, YHyi002, etc., according to device owner identification information of user b contained in the QR code such as user information, mobile phone number and the like of user b, etc., wherein YHyi001 is of better signal strength, while YHyi002 is of poorer signal strength. The server then determines corresponding authorized connection permission for the user according to the authorization identification information in the QR code and authority information which is granted to user a by user b. For example, if user a is marked as a friend with high authority such as a relative in user b-related information, and an authorization code in authorization identification information of user a matches one of authorization codes pre-stored by user b, the server grants connection permission to connect to the wireless access points such as YHyi001, YHyi002, etc., to user a. As another example, if user a is marked as a friend with general authority such as a stranger in user b-related information, and an authorization code in authorization identification information of user a matches one of authorization codes pre-stored by user b, the server grants connection permission to connect to a wireless access point such as YHyi002, etc., to user a. As yet another example, if user a is marked as a friend in blacklist with no authority in user b-related information, and an authorization code in authorization identification information of user a matches one of authorization codes pre-stored by user b, the server would not grant connection permission to connect to any of the wireless access points such as YHyi001, YHyi002, etc., to user a.

As another example, a user holds a mobile phone. The user goes to WD mall for shopping. There are wireless access point(s) matching mall identification information corresponding to the mall, and this mapping relationship is stored in a server. User a scans a QR code corresponding to connection authorization from the mall through the mobile phone, and transmits a connection authorization request containing the QR code to the server. The server queries, in a database, wireless access points in the mall such as wireless access points SC001, SC002, etc., according to mall identification information contained in the QR code such as a serial number composed of location information, name information of the mall, etc. The server then determines corresponding authorized connection permission for the user according to the authorization identification information in the QR code and authority information which is granted to the user by the mall. For example, if the mall marks the user as possessing a connection authorization relationship with high authority according to the user's historical shopping information (e.g., the user's purchasing power is strong, the user's shopping frequency is high, and so on), and an authorization code in authorization identification information of the user matches one of authorization codes pre-stored by the mall, the server grants connection permission to connect to the wireless access points such as SC001, SC002, etc., to the user. As another example, if the mall marks the user as possessing a connection authorization relationship with general authority according to the user's historical shopping information (e.g., the user's purchasing power is general, and so on), and an authorization code in authorization identification information of the user matches one of authorization codes pre-stored by the mall, the server grants, to the user, connection permission to connect to some of the wireless access points such as SC001, SC002, etc., for example, connection permission to a wireless access point on the floor where the user often goes for shopping. As yet another example, if the mall marks the user as possessing a connection authorization relationship with zero authority according to the user's historical shopping information (e.g., the user's credibility is zero since the user did Dine and Dash multiple times, and so on), and an authorization code in authorization identification information of the user matches one of authorization codes pre-stored by the mall, the server would not grant connection permission to connect to any of the wireless access points such as SC001, SC002, etc., to the user.

Of course, the above mentioned authority information is merely an example. Other existing authority information or those that may appear in the future fall within the protection scope of the application and are incorporated herein by reference, if applicable to the present application.

In some embodiments, the method further comprises step S14 (not shown). In step S14, if it is determined to authorize the user equipment to connect to the wireless access point corresponding to the QR code, the network device transmits authorization success information to the user equipment. For example, if the network device determines to authorize the user equipment to connect to the wireless access point corresponding to the QR code, the network device transmits, to the user equipment, authorization success information such as prompt information on authorization success, etc.

For example, if a server determines that the mobile phone is authorized to connect to the wireless access point corresponding to the QR code, the server transmits prompt information on authorization success to the mobile phone. In one embodiment, the authorization success information may further contain information such as an access point name corresponding to the wireless access point with authorization to the mobile phone.

In some embodiments, the connection authorization request further comprises ticket verification information obtained by the user equipment through scanning the QR code. The method further comprises step S15 (not shown). In step S15, the network device determines whether to permit admission of a user holding the user equipment according to the ticket verification information. For example, the user equipment scans a QR code of ticket verification information on a certain admission ticket based on the user's operation, and transmits a ticket containing the QR code of ticket verification information to the network device. The network device receives connection authorization information, and determines whether to permit admission of the user corresponding to the user equipment based on the ticket verification information. In some embodiments, in step S12, if the admission of the user holding the user equipment is permitted, the network device determines whether to authorize the user equipment to connect to the wireless access point corresponding to the QR code based on the authorization identification information. For example, if the network device determines that the ticket verification information matches preset information on a ticket, the network device permits admission of the user, and determines whether to authorize the user equipment to connect to the wireless access point corresponding to the QR code based on the authorization identification information and the like at the same time.

For example, a user holds a mobile phone. The user is prepared to go to SH library to read books. The user scans a QR code of an admission and connection authorization corresponding to SH library on an admission ticket for the library through the mobile phone, and transmits a connection authorization request containing the QR code to the server. The server compares the ticket verification information contained in the QR code with the information on tickets stored in a database for a match. If they are consistent, the server permits admission of the user to the library. The server further determines multiple wireless access points corresponding to the QR code such as SHTSG001, SHTSG002, etc. The server then determines whether to authorize the mobile phone to connect to the multiple wireless access points such as SHTSG001, SHTSG002, etc., according to authorization identification information in the QR code.

Of course, the above mentioned ticket verification information is merely an example. Other existing ticket verification information or those that may appear in the future fall within the protection scope of the application and are incorporated herein by reference, if applicable to the present application.

FIG. 3 shows a method, implemented at a wireless routing device, for authorizing a user equipment to connect to a wireless access point according to another aspect of the present application. The method comprises step S21 and step S22. In step S21, the wireless routing device receives authorization instruction information which is transmitted by a network device and corresponds to a wireless access point provided by the wireless routing device, wherein the authorization instruction information comprises equipment identification information of the user equipment. In step S22, the wireless routing device executes the authorization instruction information to authorize the user equipment to connect to the wireless access point. For example, the authorization instruction information includes but is not limited to equipment identification information of the user equipment, such as MAC address information of the user equipment, etc., for the wireless routing device to directly validate authentication and establish a wireless connection when the user equipment transmits a connection authentication request. If the network device authorizes the user equipment to connect to the wireless access point corresponding to the QR code, the network device transmits authorization instruction information to a wireless routing device corresponding to the wireless access point. The wireless routing device receives the authorization instruction information, and authorizes the user equipment to connect to the wireless access point according to the authorization instruction information.

For example, a user holds a mobile phone. The user uses the mobile phone to scan a QR code for wireless connection authorization in a mall. The mobile phone scans the QR code with a camera device and obtains an authorization code corresponding to the QR code. The authorization code may be generated based on mall-related information, user-related information, time and the like which are built in the QR code. If the mall is WD mall and the user-related information is user name of JIA, corresponding authorization code is generated as WD-JIA-20180601. The mobile phone then transmits a connection authorization request for the wireless connection authorization in the mall to a server, wherein the connection authorization request comprises the authorization code corresponding to the QR code. The server receives the connection authorization request, and determines that corresponding scene is WD mall based on the authorization code in the connection authorization request as well as an encoding rule for the authorization code, and then queries, in a database of wireless access points, available wireless access points corresponding to WD mall, such as multiple wireless access points WD001, WD002, etc. If the authorization code conforms to the encoding rule, the server authorizes the user equipment to connect to wireless access points WD001, WD002, etc. Alternatively, the server stores some authorization codes uploaded by a merchant, and the server compares the authorization code uploaded by the mobile phone with the authorization codes uploaded by this merchant for a match. If the authorization code uploaded by the mobile phone matches one of the authorization codes uploaded by the same merchant, the server authorizes the user equipment to connect to wireless access points WD001, WD002, etc. The server then transmits authorization instruction information to wireless routing devices corresponding to wireless access points WD001, WD002, etc., wherein the authorization instruction information comprises MAC address information of the mobile phone. The wireless routing devices corresponding to wireless access points WD001, WD002, etc., receive the authorization instruction information, and execute the authorization instruction information to authorize wireless connection to the MAC address corresponding to the mobile phone.

In some embodiments, the method further comprises step S23 (not shown). In step S23, if a connection authentication request transmitted by the user equipment to the wireless access point corresponding to the wireless routing device is received, and the user equipment has been authorized to connect to the wireless access point, the wireless routing device transmits authentication pass response information to the user equipment. For example, if the wireless routing device receives the connection authentication request from the user equipment, the wireless routing device directly returns authentication response pass information without authentication.

For example, when the mobile phone transmits a connection authentication request to wireless access point WD001 provided by a wireless routing device, the wireless routing device recognizes the MAC address information of the mobile phone in the connection authentication request, and returns corresponding authentication pass response information directly to the mobile phone. The mobile phone receives the authentication pass response information, and a wireless connection between the mobile phone and wireless access point WD001 is established.

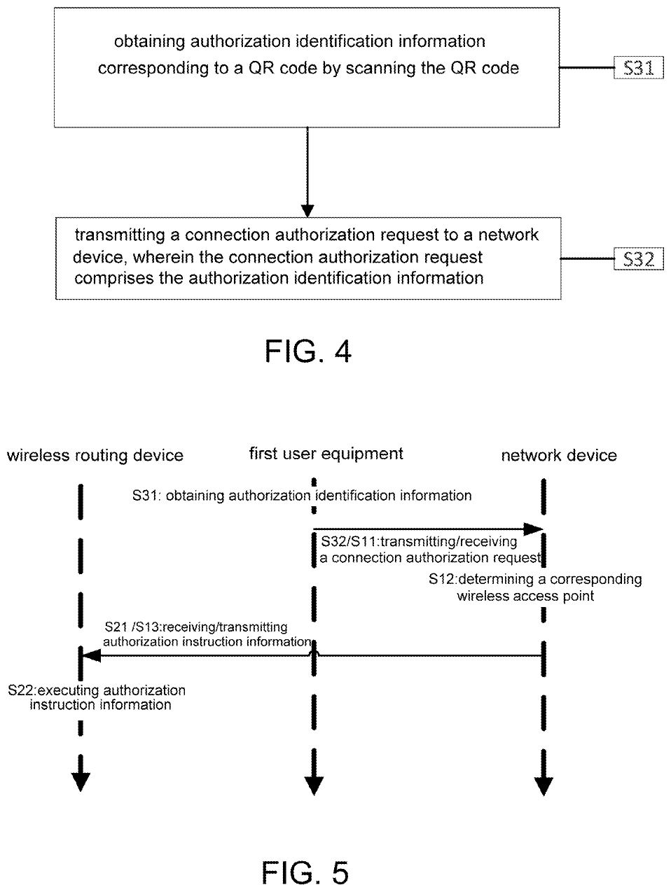

FIG. 4 shows a method, implemented at a user equipment, for authorizing the user equipment to connect to a wireless access point according to yet another aspect of the present application. The method comprises step S31 and step S32. In step S31, the user equipment obtains authorization identification information corresponding to a QR code by scanning the QR code. In step S32, the user equipment transmits a connection authorization request to a network device, wherein the connection authorization request comprises the authorization identification information. For example, the connection authorization request includes but is not limited to authorization identification information obtained by the user equipment through scanning a QR code, wherein the authorization identification information includes but is not limited to an authorization code obtained by a user through scanning a QR code, and corresponding scene identification information obtained by a user through scanning a QR code, etc. The user holds a user equipment such as a mobile phone, etc. The user equipment scans a QR code through a camera device based on the user's operation to obtain corresponding authorization identification information, and transmits a connection authorization request to the network device.

For example, a user holds a mobile phone. The user uses the mobile phone to scan a QR code for wireless connection authorization in a mall. The mobile phone scans the QR code with a camera device and obtains an authorization code corresponding to the QR code. The authorization code may be generated based on mall-related information, user-related information, time and the like which are built in the QR code. If the mall is WD mall and the user-related information is user name of JIA, corresponding authorization code is generated as WD-JIA-20180601. The mobile phone then transmits a connection authorization request for the wireless connection authorization in the mall to a server, wherein the connection authorization request comprises the authorization code corresponding to the QR code. The server receives the connection authorization request, and determines that corresponding scene is WD mall based on the authorization code in the connection authorization request as well as an encoding rule for the authorization code, and then queries, in a database of wireless access points, available wireless access points corresponding to WD mall, such as multiple wireless access points WD001, WD002, etc. If the authorization code conforms to the encoding rule, the server authorizes the user equipment to connect to wireless access points WD001, WD002, etc. Alternatively, the server stores some authorization codes uploaded by a merchant, and the server compares the authorization code uploaded by the mobile phone with the authorization codes uploaded by this merchant for a match. If the authorization code uploaded by the mobile phone matches one of the authorization codes uploaded by the same merchant, the server authorizes the user equipment to connect to wireless access points WD001, WD002, etc. The server then transmits authorization instruction information to wireless routing devices corresponding to wireless access points WD001, WD002, etc., wherein the authorization instruction information comprises MAC address information of the mobile phone. The wireless routing devices corresponding to wireless access points WD001, WD002, etc., receive the authorization instruction information, and execute the authorization instruction information to authorize wireless connection to the MAC address corresponding to the mobile phone. When the mobile phone transmits a connection authentication request to wireless access point WD001 provided by a wireless routing device, the wireless routing device recognizes the MAC address information of the mobile phone in the connection authentication request, and returns corresponding authentication pass response information directly to the mobile phone. The mobile phone receives the authentication pass response information, and a wireless connection between the mobile phone and wireless access point WD001 is established.

In some embodiments, the method further comprises step S33 (not shown). In Step S33, the user equipment receives and presents authorization success information transmitted by the network device. For example, if the network device determines to authorize the user equipment to connect to the wireless access point corresponding to the QR code, the network device transmits, to the user equipment, authorization success information such as prompt information on authorization success, etc.

For example, if a server determines that the mobile phone is authorized to connect to the wireless access point corresponding to the QR code, the server transmits prompt information on authorization success to the mobile phone. In one embodiment, the authorization success information may further contain information such as an access point name corresponding to the wireless access point with authorization to the user equipment.

In some embodiments, in step S31, the user equipment scans the QR code with a camera device of the user equipment to obtain an access link to authorization information, and accesses the access link to the authorization information to obtain authorization identification information corresponding to the QR code.

For example, the user equipment scans a QR code to obtain a corresponding link for accessing a webpage, and the webpage contains authorization-related information. The user equipment uses the authorization-related information as the authorization identification information corresponding to the QR code.

In some embodiments, in step S31, the user equipment obtains the authorization identification information and ticket verification information corresponding to the QR code by scanning the QR code on an admission ticket. In step S32, the user equipment transmits the connection authorization request to the network device, wherein the connection authorization request comprises the authorization identification information and the ticket verification information. For example, the user equipment scans a QR code of ticket verification information on a certain admission ticket based on the user's operation, and transmits a ticket containing the QR code of ticket verification information to the network device. The network device receives connection authorization information, and determines whether to permit admission of the user corresponding to the user equipment based on the ticket verification information. If the network device determines that the ticket verification information matches preset information on a ticket, the network device permits admission of the user, and determines whether to authorize the user equipment to connect to the wireless access point corresponding to the QR code based on the authorization identification information and the like at the same time.

For example, a user holds a mobile phone. The user is prepared to go to SH library to read books. The user scans a QR code of an admission and connection authorization corresponding to SH library on an admission ticket for the library through the mobile phone, and transmits a connection authorization request containing the QR code to the server. The server compares the ticket verification information contained in the QR code with the information on tickets stored in a database for a match. If they are consistent, the server permits admission of the user to the library. The server further determines multiple wireless access points corresponding to the QR code such as SHTSG001, SHTSG002, etc. The server then determines whether to authorize the mobile phone to connect to the multiple wireless access points such as SHTSG001, SHTSG002, etc. according to authorization identification information in the QR code.

FIG. 5 shows a method for authorizing a user equipment to connect to a wireless access point according to an aspect of the present application. The method comprises:

obtaining, by the user equipment, authorization identification information corresponding to an QR code by scanning the QR code, and transmitting a connection authorization request to a network device, wherein the connection authorization request comprises the authorization identification information;

receiving, by the network device, the connection authorization request, and determining whether to authorize the user equipment to connect to a wireless access point corresponding to the QR code based on the authorization identification information;

if the user equipment is authorized to connect to the wireless access point corresponding to the QR code, transmitting, by the network device, corresponding authorization instruction information to a wireless routing device which provides the wireless access point, wherein the authorization instruction information comprises equipment identification information of the user equipment;

receiving, by the wireless routing device, the authorization instruction information, and executing the authorization instruction information to authorize the user equipment to connect to the wireless access point.

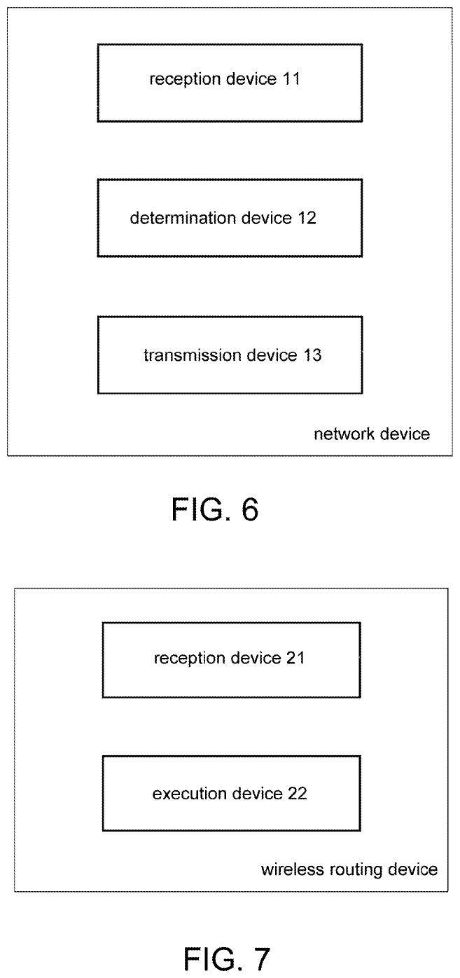

FIG. 6 shows a network device for authorizing a user equipment to connect to a wireless access point according to an aspect of the present application. The device comprises a reception device 11, a determination device 12, and a transmission device 13. The reception device 11 is used to receive a connection authorization request uploaded by the user equipment, wherein the connection authorization request comprises authorization identification information obtained by the user equipment through scanning a QR code. The determination device 12 is used to determine whether to authorize the user equipment to connect to a wireless access point corresponding to the QR code based on the authorization identification information. The transmission device 13 is used to transmit corresponding authorization instruction information to a wireless routing device which provides the wireless access point if the user equipment is authorized to connect to the wireless access point corresponding to the QR code, wherein the authorization instruction information comprises equipment identification information of the user equipment.

Specifically, the reception device 11 is used to receive a connection authorization request uploaded by the user equipment, wherein the connection authorization request comprises authorization identification information obtained by the user equipment through scanning a QR code. For example, the connection authorization request includes but is not limited to authorization identification information obtained by the user equipment through scanning a QR code, wherein the authorization identification information includes but is not limited to an authorization code obtained by a user through scanning a QR code, and corresponding scene identification information obtained by a user through scanning a QR code, etc. The user holds a user equipment such as a mobile phone, etc. The user equipment scans a QR code through a camera device based on the user's operation to obtain corresponding authorization identification information, and transmits a connection authorization request to the network device. The network device receives the connection authorization request.

The determination device 12 is used to determine whether to authorize the user equipment to connect to the wireless access point corresponding to the QR code based on the authorization identification information.

The transmission device 13 is used to transmit corresponding authorization instruction information to a wireless routing device which provides the wireless access point if the user equipment is authorized to connect to the wireless access point corresponding to the QR code, wherein the authorization instruction information comprises equipment identification information of the user equipment. For example, the authorization instruction information includes but is not limited to equipment identification information of the user equipment, such as MAC address information of the user equipment, etc., for the wireless routing device to directly validate authentication and establish a wireless connection when the user equipment transmits a connection authentication request. If the network device authorizes the user equipment to connect to the wireless access point corresponding to the QR code, the network device transmits authorization instruction information to a wireless routing device corresponding to the wireless access point.

For example, a user holds a mobile phone. The user uses the mobile phone to scan a QR code for wireless connection authorization in a mall. The mobile phone scans the QR code with a camera device and obtains an authorization code corresponding to the QR code. The authorization code may be generated based on mall-related information, user-related information, time and the like which are built in the QR code. If the mall is WD mall and the user-related information is user name of JIA, corresponding authorization code is generated as WD-JIA-20180601. The mobile phone then transmits a connection authorization request for the wireless connection authorization in the mall to a server, wherein the connection authorization request comprises the authorization code corresponding to the QR code. The server receives the connection authorization request, and determines that corresponding scene is WD mall based on the authorization code in the connection authorization request as well as an encoding rule for the authorization code, and then queries, in a database of wireless access points, available wireless access points corresponding to WD mall, such as multiple wireless access points WD001, WD002, etc. If the authorization code conforms to the encoding rule, the server authorizes the user equipment to connect to wireless access points WD001, WD002, etc. Alternatively, the server stores some authorization codes uploaded by a merchant, and the server compares the authorization code uploaded by the mobile phone with the authorization codes uploaded by this merchant for a match. If the authorization code uploaded by the mobile phone matches one of the authorization codes uploaded by the same merchant, the server authorizes the user equipment to connect to wireless access points WD001, WD002, etc. The server then transmits authorization instruction information to wireless routing devices corresponding to wireless access points WD001, WD002, etc., wherein the authorization instruction information comprises MAC address information of the mobile phone. The wireless routing devices corresponding to wireless access points WD001, WD002, etc., receive the authorization instruction information, and execute the authorization instruction information to authorize wireless connection to the MAC address corresponding to the mobile phone. When the mobile phone transmits a connection authentication request to wireless access point WD001 provided by a wireless routing device, the wireless routing device recognizes the MAC address information of the mobile phone in the connection authentication request, and returns corresponding authentication pass response information directly to the mobile phone. The mobile phone receives the authentication pass response information, and a wireless connection between the mobile phone and wireless access point WD001 is established.

Of course, the above mentioned authorization identification information is merely an example. Other existing authorization identification information or those that may appear in the future fall within the protection scope of the application and are incorporated herein by reference, if applicable to the present application.

In some embodiments, the connection authorization information further comprises identification information of the wireless access point corresponding to the QR code. The determination device 12 is used to determine whether to authorize the user equipment to connect to the wireless access point corresponding to the identification information of the wireless access point based on the authorization identification information. For example, the connection authorization information further comprises access point identification information of the wireless access point corresponding to the QR code. The network device determines whether to authorize the user equipment to connect to the wireless access point corresponding to the access point identification information based on the authorization identification information.

For example, a server receives a connection authorization request transmitted by a user equipment, wherein the connection authorization request comprises authorization identification information obtained through scanning of a QR code as well as access point identification information of multiple wireless access points in WD mall contained in the QR code such as wireless access points WD001, WD002, etc. The server determines whether the authorization identification information satisfies an authorization condition, for example, whether an authorization code satisfies a preset encoding rule or matches one of authorization codes of a merchant received by the server. If so, the server determines to authorize a mobile phone to connect to the wireless access points such as WD001, WD002, etc. The server then transmits authorization instruction information to wireless routing devices corresponding to wireless access points WD001, WD002, etc., wherein the authorization instruction information comprises MAC address information of the mobile phone.

Of course, the above mentioned identification information of a wireless access point is merely an example. Other existing identification information of the wireless access point or those that may appear in the future fall within the protection scope of the application and are incorporated herein by reference, if applicable to the present application.

In some embodiments, the determination device 12 comprises a determination device 121 (not shown) and an authorization device 122 (not shown). The determination device 121 is used to determine the wireless access point corresponding to the QR code. The authorization device 122 is used to determine whether to authorize the user equipment to connect to the wireless access point based on the authorization identification information. For example, the network device determines the wireless access point corresponding to the QR code, such as an available wireless access point in the vicinity contained in the QR code to which the user equipment was pre-connected, and determines whether to authorize the user equipment to connect to the wireless access point based on the authorization identification information.

For example, a server receives a connection authorization request transmitted by a mobile phone. The connection authorization request contains access point identification information of multiple wireless access points in WD mall contained in the QR code currently scanned by the mobile phone such as wireless access points WD001, WD002, etc. Alternatively, the authorization request contains identification information of WD mall contained in the QR code scanned by the user equipment. The server stores a mapping relationship between identification information of the mall and the wireless access points. The server determines corresponding wireless access points according to the identification information of WD mall. The server then determines whether the authorization identification information satisfies an authorization condition, for example, whether an authorization code satisfies a preset encoding rule or matches one of authorization codes of a merchant received by the server. If so, the server determines to authorize the mobile phone to connect to the wireless access points such as WD001, WD002, etc. The server then transmits authorization instruction information to wireless routing devices corresponding to wireless access points WD001, WD002, etc., wherein the authorization instruction information comprises MAC address information of the mobile phone.

In some embodiments, the determination device 121 is used to determine information on an activity event corresponding to the QR code, and query and obtain, in a database of wireless access points, a registered wireless access point corresponding to the activity event as the wireless access point corresponding to the QR code, according to the information on the activity event. For example, the user equipment scans QR code information corresponding to information on a certain activity event such as a concert, a rally, etc., based on the user's operation. The QR code information contains identification information of the activity event corresponding to the information on the activity event. The network device stores wireless access point(s) registered to the identification information of the activity event. The network device determines corresponding information on the activity event according to a QR code uploaded by the user, and queries and determines a corresponding wireless access point in a database as the wireless access point corresponding to the QR code.

For example, a user holds a mobile phone. The user is prepared to go to XX concert. The user scans a QR code corresponding to connection authorization on an admission ticket for XX concert through the mobile phone, and transmits a connection authorization request containing the QR code to a server. The server queries, in a database, multiple wireless access points registered to a venue of the concert such as wireless access points XXYCH001, XXYCH002, etc. according to concert identification information of XX concert contained in the QR code such as a serial number composed of a leading actor and time and the like of the concert, etc. The server then determines whether to authorize the mobile phone to connect to the multiple wireless access points such as XXYCH001, XXYCH002, etc. according to authorization identification information in the QR code.

Of course, the above mentioned information on the activity event is merely an example. Other existing information on the activity event or those that may appear in the future fall within the protection scope of the application and are incorporated herein by reference, if applicable to the present application.

In some embodiments, the determination device 121 is used to determine information on a venue corresponding to the QR code, and query and obtain, in a database of wireless access points, a wireless access point deployed by the corresponding venue as the wireless access point corresponding to the QR code, according to the information on the venue. For example, the user equipment scans QR code information corresponding to information on a certain venue such as a museum, a library, etc. based on the user's operation. The QR code information contains identification information of the venue corresponding to the information on the venue. The network device stores wireless access point(s) deployed by the venue. The network device determines corresponding information on the venue according to a QR code uploaded by the user, and queries and determines a wireless access point corresponding to the venue in a database as the wireless access point corresponding to the QR code.

For example, a user holds a mobile phone. The user is prepared to go to SH library to read books. The user scans a QR code for connection authorization corresponding to SH library on an admission ticket for the library through the mobile phone, and transmits a connection authorization request containing the QR code to the server. The server queries, in a database, multiple wireless access points registered to a venue of SH library such as wireless access points SHTSG001, SHTSG002, etc. according to identification information of SH library contained in the QR code, such as a serial number composed of a location and a name of the library, etc. The server then determines whether to authorize the mobile phone to connect to the multiple wireless access points such as SHTSG001, SHTSG002, etc. according to authorization identification information in the QR code.

Of course, the above mentioned information on the venue is merely an example. Other existing information on the venue or those that may appear in the future fall within the protection scope of the application and are incorporated herein by reference, if applicable to the present application.

In some embodiments, the determination device 121 is used to determine information on a wireless routing device corresponding to the QR code, and query and obtain, in a database of wireless access points, a wireless access point provided by the corresponding wireless routing device as the wireless access point corresponding to the QR code, according to the information on the wireless routing device. For example, the user equipment scans QR code information corresponding to a certain wireless routing device based on the user's operation. The QR code information comprises device identification information of the wireless routing device corresponding to the wireless routing device, such as MAC address information of the wireless routing device. The network device stores wireless access point(s) provided by the wireless routing device. The network device determines a corresponding wireless routing device according to the QR code uploaded by the user, and queries and determines a wireless access point corresponding to the wireless routing device in a database as the wireless access point corresponding to the QR code.

For example, a user holds a mobile phone. The user is going to a certain square for a visit where a wireless routing device is installed. The user scans a QR code corresponding to connection authorization in the vicinity of the wireless routing device on the square through the mobile phone, and transmits a connection authorization request containing the QR code to a server. The server queries, in a database, multiple wireless access points provided by the wireless routing device, such as wireless access points GC001, GC002, etc. according to device identification information of the wireless routing device contained in the QR code, such as MAC address information of the wireless routing device, etc. The server then determines whether to authorize the mobile phone to connect to the multiple wireless access points such as GC001, GC002 etc. according to authorization identification information in the QR code.

In some embodiments, the determination device 121 is used to determine information on a device owner corresponding to the QR code, and query and obtain, in a database of wireless access points, a wireless access point owned by the corresponding device owner as the wireless access point corresponding to the QR code, according to the information on the device owner. For example, the user equipment scans a QR code information corresponding to a device owner based on the user's operation. The QR code information contains user identification information corresponding to the device owner, such as user-related information, mobile phone number and the like of the device owner, etc. The network device stores wireless access point(s) owned by the device owner. The network device determines the corresponding device owner according to the QR code uploaded by the user, and queries and determines a wireless access point owned by the device owner in a database as the wireless access point corresponding to the QR code.

For example, user a holds a mobile phone. User a goes to user b's home to for a visit. Mobile phone B corresponding to user b has been bound to wifi at user b's place, and this mapping relationship is stored in a server. User a scans a QR code corresponding to connection authorization from user b through the mobile phone, and transmits a connection authorization request containing the QR code to the server. The server queries a wireless access point bound to user b such as YHyi001 in a database according to device owner identification information of user b contained in the QR code such as user information, mobile phone number and the like of user b, etc. The server then determines whether to authorize the mobile phone to connect to the wireless access point YHyi001 according to the authorization identification information in the QR code.

Of course, the above mentioned information on the device owner is merely an example. Other existing information on the device owner or those that may appear in the future fall within the protection scope of the application and are incorporated herein by reference, if applicable to the present application.

In some embodiments, the authorization device 122 is used to determine whether to authorize the user equipment to connect to the wireless access point based on the authorization identification information as well as authority information which is granted to a user holding the user equipment by a provider of the wireless access point;

wherein the authority information comprises any one of the following:

permission to connect to all of the wireless access points of the provider;

permission to connect to parts of the wireless access points of the provider, wherein parts of the wireless access point cover an area of the provider where the user is active;

prohibition from connecting to the wireless access point.

For example, the network device stores authority information which is granted to a user of the user equipment by a provider of the wireless access point. The network device determines whether to authorize the user equipment to connect to the wireless access point based on the authorization identification information, and further determines permission to connect to the wireless access point for the user based on the authority information. The permission includes but is not limited to: permission to connect to all of the wireless access points of the provider; permission to connect to parts of the wireless access points of the provider, wherein parts of the wireless access point cover an area of the provider where the user is active; prohibition from connecting to the wireless access point.

For example, user a holds a mobile phone. User a goes to user b's home to for a visit. Mobile phone B corresponding to user b has been bound to wifi at user b's place, and this mapping relationship is stored in a server. User a scans a QR code corresponding to connection authorization from user b through the mobile phone, and transmits a connection authorization request containing the QR code to the server. The server queries, in a database, wireless access points bound to user b such as wireless access points YHyi001, YHyi002, etc. according to device owner identification information of user b contained in the QR code such as user information, mobile phone number and the like of user b, etc., wherein YHyi001 is of better signal strength, while YHyi002 is of poorer signal strength. The server then determines corresponding authorized connection permission for the user according to the authorization identification information in the QR code and authority information which is granted to user a by user b. For example, if user a is marked as a friend with high authority such as a relative in user b-related information, and an authorization code in authorization identification information of user a matches one of authorization codes pre-stored by user b, the server grants connection permission to connect to the wireless access points such as YHyi001, YHyi002, etc. to user a. As another example, if user a is marked as a friend with general authority such as a stranger in user b-related information, and an authorization code in authorization identification information of user a matches one of authorization codes pre-stored by user b, the server grants connection permission to connect to the wireless access point such as YHyi002, etc. to user a. As yet another example, if user a is marked as a friend in blacklist with no authority in user b-related information, and an authorization code in authorization identification information of user a matches one of authorization codes pre-stored by user b, the server would not grant connection permission to connect to any of the wireless access points such as YHyi001, YHyi002, etc. to user.

As another example, a user holds a mobile phone. The user goes to WD mall for shopping. There are wireless access point(s) matching mall identification information corresponding to the mall, and this mapping relationship is stored in a server. User a scans a QR code corresponding to connection authorization from the mall through the mobile phone, and transmits a connection authorization request containing the QR code to the server. The server queries, in a database, wireless access points in the mall such as wireless access points SC001, SC002, etc. according to mall identification information contained in the QR code such as a serial number composed of location information, name information of the mall, etc. The server then determines corresponding authorized connection permission for the user according to the authorization identification information in the QR code and authority information which is granted to the user by the mall. For example, if the mall marks the user as possessing a connection authorization relationship with high authority according to the user's historical shopping information (e.g., the user's purchasing power is strong, the user's shopping frequency is high, and so on), and an authorization code in authorization identification information of the user matches one of authorization codes pre-stored by the mall, the server grants connection permission to connect to the wireless access points such as SC001, SC002, etc., to the user. As another example, if the mall marks the user as possessing a connection authorization relationship with general authority according to the user's historical shopping information (e.g., the user's purchasing power is general, and so on), and an authorization code in authorization identification information of the user matches one of authorization codes pre-stored by the mall, the server grants, to the user, connection permission to connect to some of the wireless access points such as SC001, SC002, etc., for example, connection permission to a wireless access point on the floor where the user often goes for shopping. As yet another example, if the mall marks the user as possessing a connection authorization relationship with zero authority according to the user's historical shopping information (e.g., the user's credibility is zero since the user did Dine and Dash multiple times, and so on), and an authorization code in authorization identification information of the user matches one of authorization codes pre-stored by the mall, the server would not grant connection permission to connect to any of the wireless access points such as SC001, SC002, etc. to the user.

Of course, the above mentioned authority information is merely an example. Other existing authority information or those that may appear in the future fall within the protection scope of the application and are incorporated herein by reference, if applicable to the present application.

In some embodiments, the device further comprises an authorization prompt device 14 (not shown). The authorization prompt device 14 is used to transmit authorization success information to the user equipment if it is determined to authorize the user equipment to connect to the wireless access point corresponding to the QR code. For example, if the network device determines to authorize the user equipment to connect to the wireless access point corresponding to the QR code, the network device transmits, to the user equipment, authorization success information, such as prompt information on authorization success, etc.

For example, if a server determines that the mobile phone is authorized to connect to the wireless access point corresponding to the QR code, the server transmits prompt information on authorization success to the mobile phone. In one embodiment, the authorization success information may further contain information such as an access point name corresponding to the wireless access point with authorization to the mobile phone.

In some embodiments, the connection authorization request further comprises ticket verification information obtained by the user equipment through scanning the QR code. The device further comprises: a ticket verification device 15. The ticket verification device 15 is used to determine whether to permit admission of a user holding the user equipment according to the ticket verification information. For example, the user equipment scans a QR code of ticket verification information on a certain admission ticket based on the user's operation, and transmits a ticket containing the QR code of ticket verification information to the network device. The network device receives connection authorization information, and determines whether to permit admission of the user corresponding to the user equipment based on the ticket verification information. In some embodiments, the determination device 12 is used to determine whether to authorize the user equipment to connect to the wireless access point corresponding to the QR code based on the authorization identification information if the admission of the user holding the user equipment is permitted. For example, if the network device determines that the ticket verification information matches preset information on a ticket, the network device permits admission of the user, and determines whether to authorize the user equipment to connect to the wireless access point corresponding to the QR code based on the authorization identification information and the like at the same time.

For example, a user holds a mobile phone. The user is prepared to go to SH library to read books. The user scans a QR code of an admission and connection authorization corresponding to SH library on an admission ticket for the library through the mobile phone, and transmits a connection authorization request containing the QR code to the server. The server compares the ticket verification information contained in the QR code with the information on tickets stored in a database for a match. If they are consistent, the server permits admission of the user to the library. The server further determines multiple wireless access points corresponding to the QR code such as SHTSG001, SHTSG002, etc. The server then determines whether to authorize the mobile phone to connect to the multiple wireless access points such as SHTSG001, SHTSG002, etc. according to authorization identification information in the QR code.

FIG. 7 shows a wireless routing device for authorizing a user equipment to connect to a wireless access point according to another aspect of the present application. The device comprises a reception device 21 and an execution device 22. The reception device 21 is used to receive authorization instruction information which is transmitted by a network device and corresponds to a wireless access point provided by the wireless routing device, wherein the authorization instruction information comprises equipment identification information of the user equipment. The execution device 22 is used to execute the authorization instruction information to authorize the user equipment to connect to the wireless access point. For example, the authorization instruction information includes but is not limited to equipment identification information of the user equipment, such as MAC address information of the user equipment, etc., for the wireless routing device to directly validate authentication and establish a wireless connection when the user equipment transmits a connection authentication request. If the network device authorizes the user equipment to connect to the wireless access point corresponding to the QR code, the network device transmits authorization instruction information to a wireless routing device corresponding to the wireless access point. The wireless routing device receives the authorization instruction information, and authorizes the user equipment to connect to the wireless access point according to the authorization instruction information.

For example, a user holds a mobile phone. The user uses the mobile phone to scan a QR code for wireless connection authorization in a mall. The mobile phone scans the QR code with a camera device and obtains an authorization code corresponding to the QR code. The authorization code may be generated based on mall-related information, user-related information, time and the like which are built in the QR code. If the mall is WD mall and the user-related information is user name of JIA, corresponding authorization code is generated as WD-JIA-20180601. The mobile phone then transmits a connection authorization request for the wireless connection authorization in the mall to a server, wherein the connection authorization request comprises the authorization code corresponding to the QR code. The server receives the connection authorization request, and determines that corresponding scene is WD mall based on the authorization code in the connection authorization request as well as an encoding rule for the authorization code, and then queries, in a database of wireless access points, available wireless access points corresponding to WD mall, such as multiple wireless access points WD001, WD002, etc. If the authorization code conforms to the encoding rule, the server authorizes the user equipment to connect to wireless access points WD001, WD002, etc. Alternatively, the server stores some authorization codes uploaded by a merchant, and the server compares the authorization code uploaded by the mobile phone with the authorization codes uploaded by this merchant for a match. If the authorization code uploaded by the mobile phone matches one of the authorization codes uploaded by the same merchant, the server authorizes the user equipment to connect to wireless access points WD001, WD002, etc. The server then transmits authorization instruction information to wireless routing devices corresponding to wireless access points WD001, WD002, etc., wherein the authorization instruction information comprises MAC address information of the mobile phone. The wireless routing devices corresponding to wireless access points WD001, WD002, etc., receive the authorization instruction information, and execute the authorization instruction information to authorize wireless connection to the MAC address corresponding to the mobile phone.

In some embodiments, the device further comprises a response device 23 (not shown). The response device 23 is used to transmit authentication pass response information to the user equipment if a connection authentication request transmitted by the user equipment to the wireless access point corresponding to the wireless routing device is received, and the user equipment has been authorized to connect to the wireless access point. For example, if the wireless routing device receives the connection authentication request from the user equipment, the wireless routing device directly returns authentication response pass information without authentication.

For example, when the mobile phone transmits a connection authentication request to wireless access point WD001 provided by a wireless routing device, the wireless routing device recognizes the MAC address information of the mobile phone in the connection authentication request, and returns corresponding authentication pass response information directly to the mobile phone. The mobile phone receives the authentication pass response information, and a wireless connection between the mobile phone and wireless access point WD001 is established.

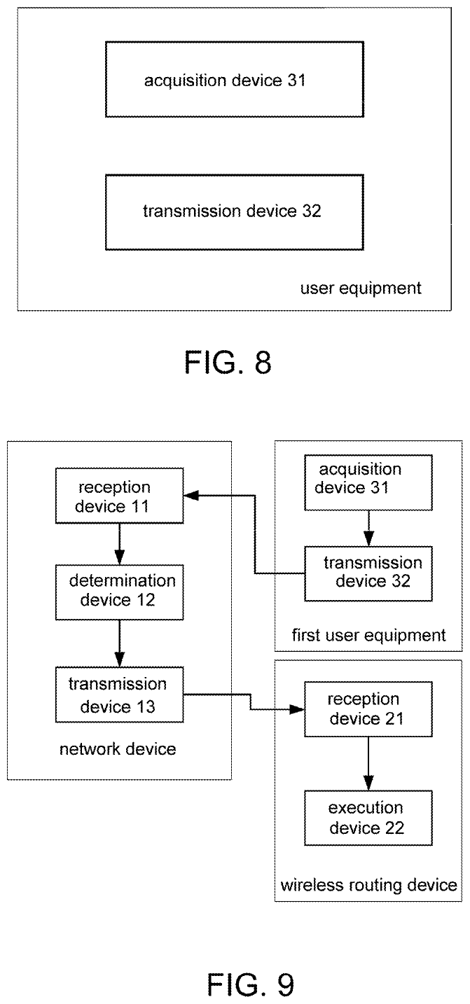

FIG. 8 shows a user equipment for authorizing the user equipment to connect to a wireless access point according to yet another aspect of the present application. The equipment comprises an acquisition device 31 and a transmission device 32. The acquisition device 31 is used to obtain authorization identification information corresponding to an QR code by scanning the QR code. The transmission device 32 is used to transmit a connection authorization request to a network device, wherein the connection authorization request comprises the authorization identification information. For example, the connection authorization request includes but is not limited to authorization identification information obtained by the user equipment through scanning a QR code, wherein the authorization identification information includes but is not limited to an authorization code obtained by a user through scanning a QR code, and corresponding scene identification information obtained by a user through scanning a QR code, etc. The user holds a user equipment such as a mobile phone, etc. The user equipment scans a QR code through a camera device based on the user's operation to obtain corresponding authorization identification information, and transmits a connection authorization request to the network device.

For example, a user holds a mobile phone. The user uses the mobile phone to scan a QR code for wireless connection authorization in a mall. The mobile phone scans the QR code with a camera device and obtains an authorization code corresponding to the QR code. The authorization code may be generated based on mall-related information, user-related information, time and the like which are built in the QR code. If the mall is WD mall and the user-related information is user name of JIA, corresponding authorization code is generated as WD-JIA-20180601. The mobile phone then transmits a connection authorization request for the wireless connection authorization in the mall to a server, wherein the connection authorization request comprises the authorization code corresponding to the QR code. The server receives the connection authorization request, and determines that corresponding scene is WD mall based on the authorization code in the connection authorization request as well as an encoding rule for the authorization code, and then queries, in a database of wireless access points, available wireless access points corresponding to WD mall, such as multiple wireless access points WD001, WD002, etc. If the authorization code conforms to the encoding rule, the server authorizes the user equipment to connect to wireless access points WD001, WD002, etc. Alternatively, the server stores some authorization codes uploaded by a merchant, and the server compares the authorization code uploaded by the mobile phone with the authorization codes uploaded by this merchant for a match. If the authorization code uploaded by the mobile phone matches one of the authorization codes uploaded by the same merchant, the server authorizes the user equipment to connect to wireless access points WD001, WD002, etc. The server then transmits authorization instruction information to wireless routing devices corresponding to wireless access points WD001, WD002, etc., wherein the authorization instruction information comprises MAC address information of the mobile phone. The wireless routing devices corresponding to wireless access points WD001, WD002, etc., receive the authorization instruction information, and execute the authorization instruction information to authorize wireless connection to the MAC address corresponding to the mobile phone. When the mobile phone transmits a connection authentication request to wireless access point WD001 provided by a wireless routing device, the wireless routing device recognizes the MAC address information of the mobile phone in the connection authentication request, and returns corresponding authentication pass response information directly to the mobile phone. The mobile phone receives the authentication pass response information, and a wireless connection between the mobile phone and wireless access point WD001 is established.

In some embodiments, the equipment further comprises an authorization prompt 33 (not shown). The authorization prompt 33 is used to receive and present authorization success information transmitted by the network device. For example, if the network device determines to authorize the user equipment to connect to the wireless access point corresponding to the QR code, the network device transmits, to the user equipment, authorization success information, such as prompt information on authorization success, etc.

For example, if a server determines that the mobile phone is authorized to connect to the wireless access point corresponding to the QR code, the server transmits prompt information on authorization success to the mobile phone. In one embodiment, the authorization success information may further contain information such as an access point name corresponding to the wireless access point with authorization to the mobile phone.

In some embodiments, the acquisition device 31 is used to scan the QR code with a camera device of the user equipment to obtain an access link to authorization information, and access the access link to the authorization information to obtain authorization identification information corresponding to the QR code.

For example, the user equipment scans a QR code to obtain a corresponding link for accessing a webpage, and the webpage contains authorization-related information. The user equipment uses the authorization-related information as the authorization identification information corresponding to the QR code.

In some embodiments, the acquisition device 31 is used to obtain the authorization identification information and ticket verification information corresponding to the QR code by scanning the QR code on an admission ticket. The transmission device 32 is used to transmit a connection authorization request to the network device, wherein the connection authorization request comprises the authorization identification information and the ticket verification information. For example, the user equipment scans a QR code of ticket verification information on a certain admission ticket based on the user's operation, and transmits a ticket containing the QR code of ticket verification information to the network device. The network device receives connection authorization information, and determines whether to permit admission of the user corresponding to the user equipment based on the ticket verification information. If the network device determines that the ticket verification information matches preset information on a ticket, the network device permits admission of the user, and determines whether to authorize the user equipment to connect to the wireless access point corresponding to the QR code based on the authorization identification information and the like at the same time.

For example, a user holds a mobile phone. The user is prepared to go to SH library to read books. The user scans a QR code of an admission and connection authorization corresponding to SH library on an admission ticket for the library through the mobile phone, and transmits a connection authorization request containing the QR code to the server. The server compares the ticket verification information contained in the QR code with the information on tickets stored in a database for a match. If they are consistent, the server permits admission of the user to the library. The server further determines multiple wireless access points corresponding to the QR code such as SHTSG001, SHTSG002, etc. The server then determines whether to authorize the mobile phone to connect to the multiple wireless access points such as SHTSG001, SHTSG002, etc. according to authorization identification information in the QR code.

FIG. 9 shows a system for authorizing a user equipment to connect to a wireless access point according to an aspect of the present application. The system comprises:

obtaining, by the user equipment, authorization identification information corresponding to an QR code by scanning the QR code, and transmitting a connection authorization request to a network device, wherein the connection authorization request comprises the authorization identification information;

receiving, by the network device, the connection authorization request, and determine whether to authorize the user equipment to connect to a wireless access point corresponding to the QR code based on the authorization identification information;

if the user equipment is authorized to connect to the wireless access point corresponding to the QR code, transmitting, by the network device, corresponding authorization instruction information to a wireless routing device which provides the wireless access point, wherein the authorization instruction information comprises equipment identification information of the user equipment; and

receiving, by the wireless routing device, the authorization instruction information, and executing the authorization instruction information to authorize the user equipment to connect to the wireless access point.

The present application also provides a computer readable storage medium storing computer codes thereon, wherein the computer codes when executed, cause the method as recited in any one of the above-mentioned clauses to be performed.

The present application also provides a computer program product, wherein the computer program product when executed by a computer device, cause the method as recited in any one of the above-mentioned clauses to be performed.

The present application also provides a computer device. The computer device comprises:

one or more processors;

a memory for storing one or more computer programs;

wherein the one or more computer programs, when executed by the one or more processors, cause the one or more processors to implement the method as recited in any one of above-mentioned clauses.

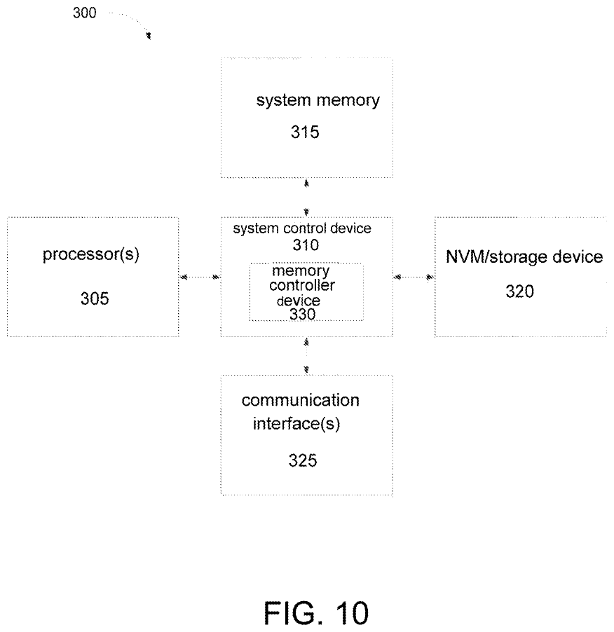

FIG. 10 shows an exemplary system which may be used to implement the various embodiments described in the present application.

As shown in FIG. 10, in some embodiments, a system 300 may be embodied as any device for authorizing a user equipment to connect to a wireless access point in the embodiments as described. In some embodiments, the system 300 may comprise one or more computer-readable media having instructions (e.g., a system memory or a NVM/storage device 320) and one or more processors coupled with the one or more computer-readable media and configured to execute the instructions to implement devices, so as to perform the actions described in the present application (e.g., processor(s) 305).

For one embodiment, a system control device 310 may comprise any suitable interface controller for providing any suitable interface for at least one of the processor(s) 305 and/or any suitable device or component in communication with the system control device 310.

The system control device 310 may comprise a memory controller device 330 for providing interface(s) for a system memory 315. The memory controller device 330 may be a hardware device, a software device and/or a firmware device.

The system memory 315 may be used to load and store data and/or instructions for the system 300 for example. For one embodiment, the system memory 315 may comprise any suitable volatile memory (e.g., a suitable DRAM). In some embodiments, the system memory 315 may comprise a double-data-rate fourth generation synchronous dynamic random access memory (DDR4SDRAM).

For one embodiment, the system control device 310 may comprise one or more input/output (I/O) controllers for providing interface(s) to the NVM/storage device 320 and the communication interface(s) 325.

For example, the NVM/storage device 320 may be used to store data and/or instructions. The NVM/storage device 320 may comprise any suitable non-volatile memory (e.g., a flash memory) and/or may comprise any suitable non-volatile storage device(s) (e.g., one or more hard disk drives (HDD), one or more compact disc (CD) drives and/or one or more digital video disc (DVD) drives).

The NVM/storage device 320 may comprise storage resources that are physically part of a device where the system 300 is installed, or it may be accessed by the device but need not to be part of the device. For example, the NVM/storage device 320 may be accessed via the communication interface(s) 325 through a network.

The communication interface(s) 325 may provide interface(s) for the system 300 to communicate through one or more networks and/or with any other suitable devices. The system 300 may communicate with one or more components of a wireless network wirelessly according to any of one or more wireless network standards and/or protocols.

For one embodiment, at least one of the processor(s) 305 may be packaged logically with one or more controllers of the system control device 310 (e.g., the memory controller device 330). For one embodiment, at least one of the processor(s) 305 may be packaged logically with one or more controllers of the system control device 310 to form a system in package (SiP). For one embodiment, at least one of the processor(s) 305 may be integrated logically with one or more controllers of the system control device 310 on a same mold. For one embodiment, at least one of the processor(s) 305 may be integrated logically with one or more controllers of the system control device 310 on a same mold to form a system on chip (SoC).

In various embodiments, the system 300 may be but is not limited to servers, workstations, desktop computing devices or mobile computing devices (e.g., laptop computing devices, hand-held computing devices, tablets, netbooks, etc.). In various embodiments, the system 300 may have more or fewer components and/or different architectures. For example, in some embodiments, the system 300 comprises one or more cameras, keyboards, liquid crystal display (LCD) screens (comprising touch-screen displays), non-volatile memory ports, multiple antennas, graphics chips, application specific integrated circuits (ASICs) and speakers.

It should be noted that the present application can be implemented in software and/or a combination of software and hardware, for example, by using an application specific integrated circuit (ASIC), a general purpose computer, or any other similar hardware device. In one embodiment, the software program of the present application can be executed by a processor to implement the steps or functions described above. Likewise, the software programs (including related data structures) of the present application can be stored in a computer readable storage medium such as a RAM memory, a magnetic or optical drive or a floppy disk and the like. In addition, some of the steps or functions of the present application may be implemented in hardware, for example, as a circuit that cooperates with a processor to perform various steps or functions.

In addition, a portion of the present application can be embodied as a computer program product, such as computer program instructions, when executed by a computer, can invoke or provide a method in accordance with the present application. It is to be understood that computer program instructions exist in a computer-readable medium in a form of including, but not limited to, a source file, an executable file, an installation package file, and the like. Correspondingly, the manner in which a computer program instruction is executed by a computer includes, but is not limited to, the computer directly executing the instruction, or the computer compiling the instruction and then executing the corresponding compiled program, or the computer reading and executing the instruction, or the computer reading and installing the instruction and then executing the corresponding post-installation program. Here, the computer-readable medium can be any available computer-readable storage medium or communication medium that can be accessed by a computer.

Communication medium includes medium by which communication signals which include, for example, computer-readable instructions, data structures, program devices, or other data, are transmitted from one system to another. Communication medium can include guided transmission medium (such as cables and wires (e.g., fiber optics, coaxial, etc.)) and wireless (non-conductive transmission) medium that can propagate energy waves, such as sound, electromagnetic, RF, microwave, and infrared. Computer readable instructions, data structures, program devices or other data may be embodied, for example, as a modulated data signal in a wireless medium, such as a carrier wave or a similar mechanism such as being embodied as part of a spread spectrum technology. The term “modulated data signal” refers to a signal whose one or more characteristics are altered or set by encoding information in the signal. Modulation can be analog, digital, or can be hybrid modulation techniques.

By way of example and not limitation, computer-readable storage medium may include volatile and non-volatile, removable and non-removable medium implemented by any method or technology used to store information such as computer readable instructions, data structures, program devices or other data. For example, computer-readable storage medium includes, but is not limited to, volatile memory such as random access memory (RAM, DRAM, SRAM); and non-volatile memory such as flash memory, various read-only memories (ROM, PROM, EPROM, EEPROM), magnetic and ferromagnetic/ferroelectric memory (MRAM, FeRAM); and magnetic and optical storage devices (hard disk, cassette, CD, DVD); or other existing or known medium or any medium to be developed in the future that can store computer-readable information/data for use by computer systems.

Herein, an embodiment in accordance with the present application includes an apparatus including a memory for storing computer program instructions and a processor for executing program instructions, wherein when the computer program instructions are executed by the processor, triggering the apparatus to operate the above-mentioned methods in accordance with various embodiments of the present application.

It is apparent that the present application is not limited to the details of the above-mentioned exemplary embodiments, and the present application can be implemented in other specific forms without departing the spirit or basic features of the present application. Therefore, the present embodiments are to be considered as illustrative and not restrictive. The scope of the present application is defined by the appended claims rather than the above-mentioned description, and therefore it is intended that all changes which fall within the meaning and range of equivalency of the claims are embraced in the present application. Any reference signs in the claims should not be construed as limiting the claims involved. In addition, it is apparent that the word “comprising” does not exclude other elements or steps, and the singular does not exclude the plural. A plurality of units or means stated in the apparatus claims may also be implemented by one unit or means by means of software or hardware. The terms first and second and the like are used to represent names and do not represent any particular order.

What is claimed is:

1. A method, implemented at a network device, for authorizing a user equipment to connect to a wireless access point, the method comprising:
receiving a connection authorization request uploaded by the user equipment, wherein the connection authorization request comprises authorization identification information obtained by the user equipment through scanning a QR code;
determining whether to authorize the user equipment to connect to a wireless access point corresponding to the QR code based on the authorization identification information; and
if the user equipment is authorized to connect to the wireless access point corresponding to the QR code, transmitting corresponding authorization instruction information to a wireless routing device which provides the wireless access point, wherein the authorization instruction information comprises equipment identification information of the user equipment.

2. The method according to claim 1, wherein the connection authorization request further comprises identification information of the wireless access point corresponding to the QR code;
wherein the step of determining whether to authorize the user equipment to connect to the wireless access point corresponding to the QR code based on the authorization identification information comprising:
determining whether to authorize the user equipment to connect to the wireless access point corresponding to the identification information of the wireless access point based on the authorization identification information.

3. The method according to claim 1, wherein the step of determining whether to authorize the user equipment to connect to the wireless access point corresponding to the QR code based on the authorization identification information comprising:
determining the wireless access point corresponding to the QR code; and
determining whether to authorize the user equipment to connect to the wireless access point based on the authorization identification information.

4. The method according to claim 3, wherein the step of determining the wireless access point corresponding to the QR code comprising:
determining information on an activity event corresponding to the QR code; and
querying and obtaining, in a database of wireless access points, a registered wireless access point corresponding to the activity event as the wireless access point corresponding to the QR code, according to the information on the activity event.

5. The method according to claim 3, wherein the step of determining the wireless access point corresponding to the QR code comprising:
determining information on a venue corresponding to the QR code; and
querying and obtaining, in a database of wireless access points, a wireless access point deployed by the corresponding venue as the wireless access point corresponding to the QR code, according to the information on the venue.

6. The method according to claim 3, wherein the step of determining the wireless access point corresponding to the QR code comprising:
determining information on a wireless routing device corresponding to the QR code; and
querying and obtaining, in a database of wireless access points, a wireless access point provided by the corresponding wireless routing device as the wireless access point corresponding to the QR code, according to the information on the wireless routing device.

7. The method according to claim 3, wherein the step of determining the wireless access point corresponding to the QR code comprising:
determining information on a device owner corresponding to the QR code; and
querying and obtaining, in a database of wireless access points, a wireless access point owned by the corresponding device owner as the wireless access point corresponding to the QR code, according to the information on the device owner.

8. The method according to claim 4, wherein the step of querying and obtaining, in a database of wireless access points, a registered wireless access point corresponding to the activity event as the wireless access point corresponding to the QR code, according to the information on the activity event, comprising:
determining whether to authorize the user equipment to connect to the wireless access point based on the authorization identification information as well as authority information which is granted to a user holding the user equipment by a provider of the wireless access point;
wherein the authority information comprises any one of the following:
permission to connect to all of the wireless access points of the provider;
permission to connect to parts of the wireless access points of the provider, wherein parts of the wireless access points cover an area of the provider where the user is active;
prohibition from connecting to the wireless access point.

9. The method according to claim 1, wherein the method further comprising:
if the user equipment is authorized to connect to the wireless access point corresponding to the QR code, transmitting authorization success information to the user equipment.

10. The method according to claim 1, wherein the connection authorization request further comprises ticket verification information obtained by the user equipment through scanning the QR code;
wherein the method further comprising:
determining whether to permit admission of a user holding the user equipment according to the ticket verification information.

11. The method according to claim 10, wherein the step of determining whether to authorize the user equipment to connect to the wireless access point corresponding to the QR code based on the authorization identification information comprising:
if the admission of the user holding the user equipment is permitted, determining whether to authorize the user equipment to connect to the wireless access point corresponding to the QR code based on the authorization identification information.

12. A method, implemented at a user equipment, for authorizing the user equipment to connect to a wireless access point, the method comprising:
obtaining authorization identification information corresponding to a QR code by scanning the QR code; and
transmitting a connection authorization request to a network device, wherein the connection authorization request comprises the authorization identification information.

13. The method according to claim 12, wherein the method further comprising:
receiving and presenting authorization success information transmitted by the network device.

14. The method according to claim 12, wherein the step of obtaining the authorization identification information corresponding to the QR code by scanning the QR code comprising:
scanning the QR code with a camera device of the user equipment to obtain an access link to authorization information; and
accessing the access link to the authorization information to obtain the authorization identification information corresponding to the QR code.

15. The method according to claim 12, wherein the step of obtaining the authorization identification information corresponding to the QR code by scanning the QR code comprising:
obtaining the authorization identification information and ticket verification information corresponding to the QR code by scanning the QR code on an admission ticket;
wherein transmitting the connection authorization request to the network device, wherein the connection authorization request comprises the authorization identification information, comprising:
transmitting the connection authorization request to the network device, wherein the connection authorization request comprises the authorization identification information and the ticket verification information.

16. A device for authorizing a user equipment to connect to a wireless access point, the device comprising:
a processor; and
a memory arranged to store computer executable instructions, wherein the executable instructions, when executed, cause the processor to perform the following operations:
receiving a connection authorization request uploaded by the user equipment, wherein the connection authorization request comprises authorization identification information obtained by the user equipment through scanning a QR code;
determining whether to authorize the user equipment to connect to a wireless access point corresponding to the QR code based on the authorization identification information; and
if the user equipment is authorized to connect to the wireless access point corresponding to the QR code, transmitting corresponding authorization instruction information to a wireless routing device which provides the wireless access point, wherein the authorization instruction information comprises equipment identification information of the user equipment.
